(19) United States
(12) Patent Application Publication
(10) Pub. No.: US 2006/0016735 A1
(43) Pub. Date: Jan. 26, 2006

(54) Pellet separator

(75) Inventors: Takafumi Ito, Tokyo (JP); Atsushi Takayama, Tokyo (JP)

Correspondence Address: STAAS & HALSEY LLP, SUITE 700, 1201 NEW YORK AVENUE, N.W., WASHINGTON, DC, 20005, US

(73) Assignee: Satake Corporation, Tokyo (JP)

(21) Appl. No.: 11/179,615

(22) Filed: Jul. 13, 2005

(30) Foreign Application Priority Data
Jul. 13, 2004 (JP) 205442/2004

(51) Int. Cl. B07C 5/00

(52) U.S. Cl. 209/576

(57) ABSTRACT

A pellet separator capable of accurately sorting and removing defective pellets without generating false identifications of nondefective pellets as defective pellets by suppressing diffused reflection inside even resin pellets of high transparency. A first background and a second background of the pellet separator are formed in the vicinity of a parabolic trajectory and shaped to be curved along the parabolic trajectory in the downstream direction thereof.

### BACKGROUND OF THE INVENTION

1. Field of the Invention

The present invention relates to a pellet separator for removing defective pellets coated with carbon or the like from translucent resin pellets and plastic pellets that are the raw material for nylon products and the like.

2. Description of Related Art

To remove extremely minute amounts of colored pellets generated in a resin pellet production process, a resin pellet colored pellet remover that efficiently removes defective colored pellets is known (see JP 2651867B, for example).

A detailed description will now be given of a photosensor section of this colored pellet remover using FIG. 3. FIG. 3 is a diagram showing a partial expanded view of the photosensor unit, in which photodetectors 113, 114 that detect light reflected from the front of a pellet and a photoreceptor 115 that detects light reflected from the back of the pellet are disposed on opposite sides of a drop path L, with the front photoreceptors dispersed between an upstream and a downstream position along a direction of flow of the pellets, respectively, facing lines of detection P. The foregoing arrangement allows a pellet on the lines of detection P to be detected from three directions at once, and when a defective pellet (one surface of which is black with carbon) crosses one of the lines of detection P, one of the photoreceptors 113-115 detects a difference in light level between the light levels of backgrounds 118-120, which are adjusted to substantially the same light level as that of a nondefective pellet, and the light level of the defective pellet. The light level adjustment of the backgrounds 118-120 is preset using a microprocessor or the like and shifting angles so that the light level of the backgrounds 118-120 and the light level of a nondefective pellet always match. The difference between the light level of the backgrounds 118-120 (that is, the light level of a nondefective pellet) and the light level of a defective pellet is then electrically converted and compared to a preset threshold value. If the resulting signal (that is, the voltage) is greater than the threshold value, then that pellet is identified as a defective product and an ejector 124 disposed at a position opposite the photosensor unit is time-delay-operated and expels the defective pellet onto a defective pellet discharge trough, not shown.

However, in the conventional colored pellet remover, a resin pellet on a line of detection P is illuminated by a plurality of fluorescent lamps 121A-121E near the photodetectors 113-115, and anything with a high degree of transparency will cause diffused reflection inside the pellet when the pellet is irradiated with light from multiple directions at once, making it impossible to distinguish between the signals of brightly shining nondefective pellets and the signals from the small black spots of defective pellets, and resulting in the misidentification of nondefective pellets as defective pellets.

### SUMMARY OF THE INVENTION

The present invention provides a pellet separator that suppresses diffused reflection inside even resin pellets with their high transparency and is capable of accurately sorting and removing defective pellets without generating false positive identifications of nondefective pellets as defective pellets.

A pellet separator of the present invention comprises: a supplying unit for supplying pellets; a conveying unit for conveying the pellets supplied from the supplying section at a constant flow rate and a constant speed to be released in a substantially horizontal direction; a plurality of optical detecting units arranged at positions on opposite sides of a parabolic trajectory of the pellets released from the conveying section for detecting defective pellets; and a removing unit for removing defective pellet from the parabolic trajectory based on detection of defective pellets by the plurality of optical detecting units. The plurality of optical detecting units includes a first detecting unit having first illumination means for illuminating front surfaces of the pellets, a first sensor for observing the front surfaces of the pellets and a first background arranged on a side of the parabolic trajectory opposite to a side on which the first illumination means and the first sensor are arranged, and a second detecting unit having second illumination means for illuminating back surfaces of the pellets, a second sensor for observing the back surfaces of the pellets and a second background arranged on a side of the parabolic trajectory opposite to a side on which the second illumination means and the second sensor are arranged, and the first background and the second background are arranged in the vicinity of the parabolic trajectory and formed to be curved along the parabolic trajectory. The conveyer unit may comprise a continuous conveyer belt.

The first sensor and the second sensor for observing the pellets sense light levels from the corresponding first background or second background, but because the first background and the second background are in the vicinity of the parabolic trajectory, diffused reflection inside even resin pellets with their high degree of transparency can be suppressed and the bright signal of a nondefective pellet is not falsely identified as a defective pellet. In the event that a defective pellet with minute black spots falls from the edge of the conveyer belt, the first sensor or the second sensor detects the difference in reflected light level between the background and the minute black spots, thus enabling the pellet to be identified as a defective pellet.

Preferably, a distance between the first background and the parabolic trajectory and a distance between the second background and the parabolic track are not greater than 10 mm. If this distance exceeds 10 mm, diffused reflection occurs more readily inside the pellets. Consequently, diffused reflection inside the pellets can be suppressed if the distance separating the parabolic trajectory and the respective backgrounds is 10 mm or less.

The backgrounds are shaped so as to curve along the parabolic trajectory of the pellets expelled from the conveyer unit in the downstream direction, so that the pellets are not irradiated by light from the front and the back at the same time and therefore diffused reflection within the pellets can be suppressed.

### BRIEF DESCRIPTION OF THE DRAWINGS

FIG. 1 is a diagram showing a central longitudinal cross-sectional view of a pellet separator of the present invention;

FIG. 2 is a diagram showing a perspective view of the relation between the fall of a pellet and optical detecting units; and

FIG. 3 is a diagram showing a partial expanded view of a conventional colored pellet remover.

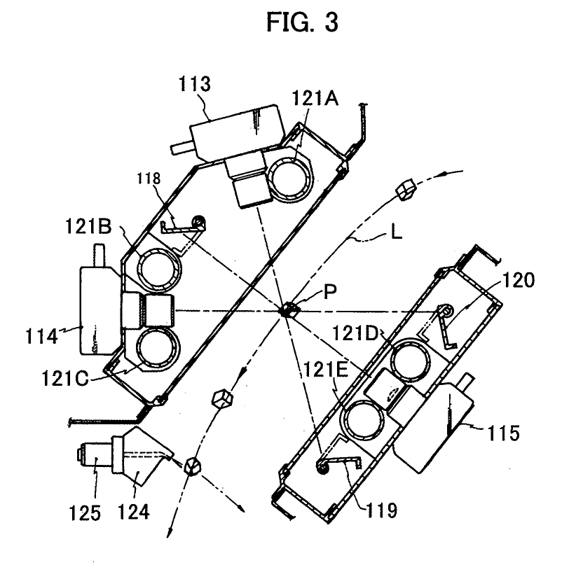

### DETAILED DESCRIPTION

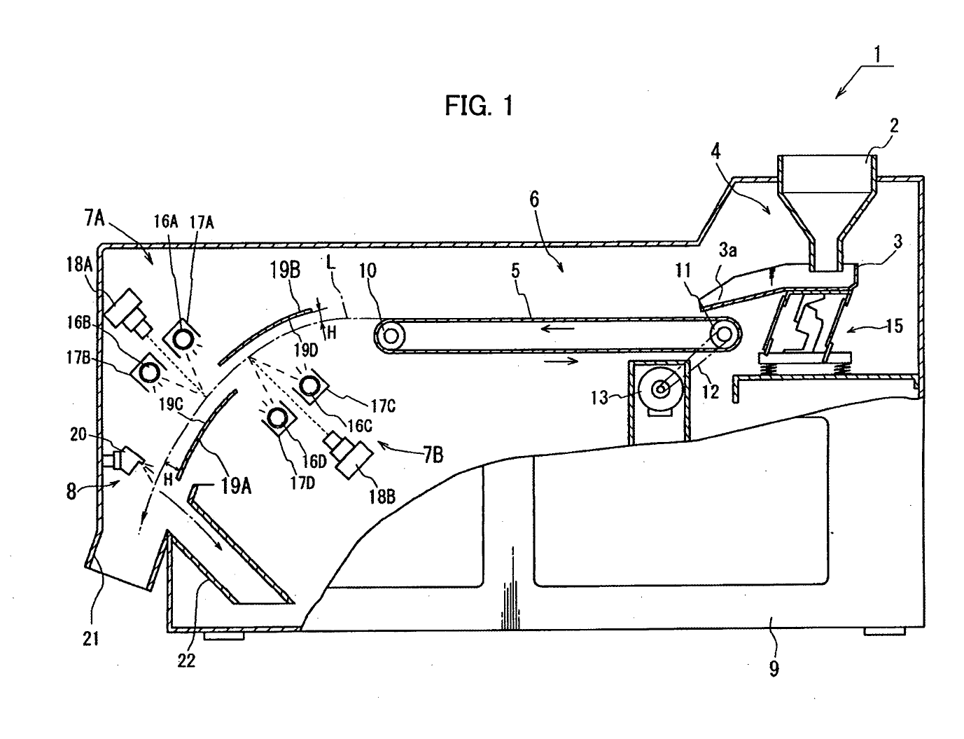

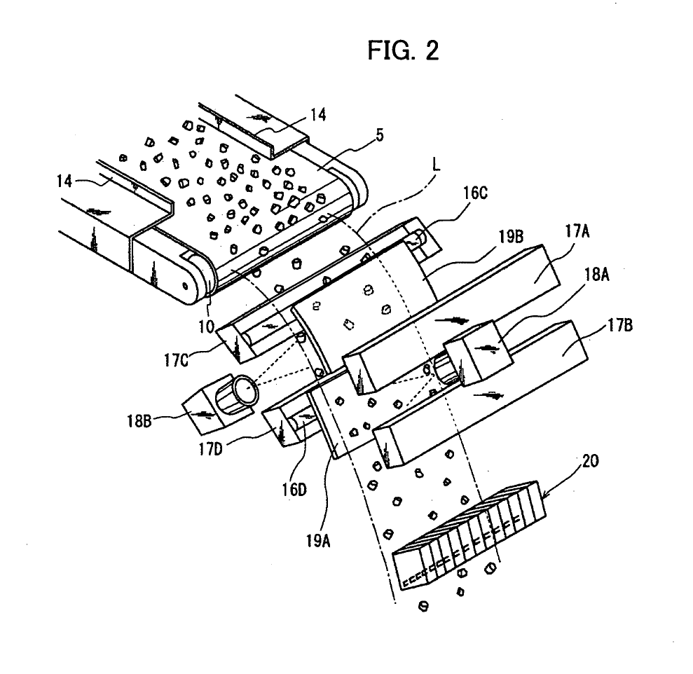

A detailed description will now be given of a preferred embodiment of the present invention, with reference to FIG. 1 and FIG. 2. FIG. 1 is a diagram showing a central longitudinal cross-sectional view of a pellet separator of the present invention, and FIG. 2 is a diagram showing a perspective view of the relation between the fall of a pellet and optical detecting units.

In FIGS. 1 and 2, a pellet separator 1 is comprised of a supply unit 2 composed of a supply hopper 3 and a supplying unit 4, a conveying unit 6 that conveys a constant volume of pellets supplied from the supplying unit 4 at a constant speed using a continuous conveyer belt 5, a plurality of optical detecting units disposed along opposite sides of a parabolic trajectory L of the pellets discharged from the conveying unit 6, and a removing unit 8 that, upon detection of a defective pellet by the plurality of optical detecting units, removes such defective pellet from the parabolic trajectory L.

The conveying unit 6 is configured so that the continuous conveyer belt spans rollers 10, 11 installed so as to be rotatable within a substantially rectangular parallelepiped machine casing 9 installed latitudinally, with the roller 11 linked to a motor 13 by a V belt 12 so as to rotate at a constant speed. A pair of side guards 14, 14 for preventing the pellets from falling off during transit are provided at right angles to the direction in which the top surface of the conveyer belt 5 (that is, the surface that conveys the pellets) travels (see FIG. 2), that is, along the edges of the conveyer belt 5.

The supplying unit 4 provided on the starting side of the conveying unit 6 faces a trough 3a of the feeder 3 that acts to supply a suitable volume of pellets, with the bottom of the feeder 3 supported by an agitator 15. The top of the feeder 3 faces the bottom of the supply hopper 2.

The plurality of optical detecting units are disposed along the parabolic trajectory L of the pellets discharged from the ending side of the conveying unit 6. That is, a first detecting unit 7A for observing the front of the pellets and a second detecting unit 7B for observing the back of the pellets (that is, the surface of the pellets that contacts the conveyer belt 5 in the conveying unit 6) are disposed on opposite sides of the parabolic trajectory L and are offset upstream and downstream of each other in the direction of the fall of the pellets.

The first detecting unit 7A is comprised of a first illumination means composed of fluorescent lamps 16A, 16B that illuminate the front of the pellets and light housings 17A, 17B for mounting the fluorescent lamps 16A, 16B, a CCD line sensor 18A for observing the front of the pellets, and a first background 19A disposed opposite the CCD line sensor 18A on the opposite side of the parabolic trajectory L from the CCD line sensor 18A.

The second detecting unit 7B is comprised of a second illumination means composed of fluorescent lamps 16C, 16D that illuminate the back of the pellets and light housings 17C, 17D for mounting the fluorescent lamps 16C, 16D, a CCD line sensor 18B for observing the back of the pellets, and a second background 19B disposed opposite the CCD line sensor 18B on the opposite side of the parabolic trajectory L from the CCD line sensor 18B.

Next, a description will be given of the shapes of the first background 19A and the second background 19B.

The first background 19A and the second background 19B are shaped so as not only to extend broadly in a direction perpendicular to the parabolic trajectory L but also to curve convexly and concavely along the parabolic trajectory L (see FIG. 2). As can be seen from FIG. 1, the second background 19B is positioned above the parabolic trajectory L and the first background is positioned below the parabolic trajectory L. For example, the first background 19A is brought within a distance H from the parabolic trajectory L of 10 mm or less (see FIG. 1), such that a curved portion 19C of the first background 19A is shaped convexly so as to extend alongside the parabolic trajectory L. Similarly, the second background 19B is brought within a distance H from the parabolic trajectory L of 10 mm or less (see FIG. 1), such that a curved portion 19D of the second background 19B is shaped convexly so as to extend alongside the parabolic trajectory L.

An array of ejectors 20 is provided in the vicinity of the parabolic trajectory L and below the plurality of optical detecting units, downstream of the inspection area of the CCD line sensors 18A, 18B (see FIG. 2). The ejectors 20 are connected to an air compressor, not shown, and the CCD line sensors 18A, 18B are connected to an electromagnetic valve operation circuit in the array of ejectors 20 so that high-pressure air is ejected from the array of ejectors 20 by electromagnetic valves, not shown, installed in each ejector 20. A nondefective pellet discharge trough 21 is provided below the ejectors 20, and a defective pellet discharge trough 22 that receives defective pellets expelled by the ejectors 20 is provided to one side of the nondefective pellet discharge trough 21.

Next, a description will be given of the operation of the foregoing embodiment.

When the raw material pellets are put into the supply hopper 2 and the agitator 15 and the motor 13 are activated, the pellets are supplied to the conveyer belt 5 in appropriate amounts by the feeder 3. The pellets thus supplied to the conveyer belt 5 are transported to the ending end of the conveyer belt 5 in the form of a thin layer. The conveyer belt 5 is driven at a rate of approximately 1.5 m/sec and the pellets that are discharged from the end of the conveyer belt 5 describe a parabolic trajectory L like that shown in the diagrams, falling between the pair of backgrounds 19A, 19B. The plurality of optical detecting units 7A, 7B are disposed around the backgrounds 19A, 19B and the falling pellets are inspected for defects thereby.

The light from the fluorescent lamps 16C, 16D irradiates the background 19B and the CCD line sensor 18B senses the amount of light (hereinafter light level) reflected from the background 19B. Then, when the pellets discharged from the end of the conveyer belt 5 reach detection position on the parabolic trajectory L, the fluorescent lamps 16C, 16D irradiate the backs of the pellets uniformly and the CCD line sensor 18B senses the reflected light therefrom. At this time, since the background 19B is near the pellets, irradiation of the pellets by light from multiple directions is suppressed and diffused reflection inside even resin pellets with their high degree of transparency can be suppressed, and therefore there are no false positive identifications of nondefective pellets as defective pellets.

If a defective pellet having a black spot as small as approximately 1 mm in diameter on the back of the pellet falls from the conveyer belt 5, the CCD line sensor 18B detects the difference in light levels between the background 19B and the minute black spot and can identify that pellet as a defective pellet. In addition, since the background 19B is formed into a concave curve that follows the parabolic trajectory L downward, a pellet falling directly beneath the background 19B is blocked from irradiation by at least the light from the fluorescent lamp 16A and the pellet is not irradiated by light from the front and the back at the same time, thus making it possible to eliminate false positive identification of a nondefective pellet as a defective pellet.

When a pellet on the parabolic trajectory L is identified as defective, the ejectors 20 corresponding to the CCD line sensor 18B inspection area are operated with a slight time delay to expel that pellet onto the defective pellet discharge trough 22.

As a pellet that has passed the CCD line sensor 18B falls further along the parabolic trajectory L, it enters the inspection area of the CCD line sensor 18A. In this inspection area, the light from the fluorescent lamps 16A, 16B irradiates the background 19A and the CCD line sensor 18A senses the amount of light (hereinafter light level) reflected from the background 19A. Then, when the pellet reaches the detection position, the fluorescent lamps 16A, 16B uniformly irradiate the front of the pellet and the CCD line sensor 18A senses the light reflected therefrom. Then, as described above, because the background 19A is near the pellet, diffused reflection inside even resin pellets with their high degree of transparency can be suppressed, and therefore there are no false positive identifications of nondefective pellets as defective pellets.

If a defective pellet having a black spot as small as approximately 1 mm in diameter on the front of the pellet falls from the conveyer belt 5, the CCD line sensor 18A detects the difference in light levels between the background 19A and the minute black spot and can identify that pellet as a defective pellet. In addition, since the background 19A is formed into a convex curve that follows the parabolic trajectory L downward, a pellet falling directly above the background 19A is blocked from irradiation by at least the light from the fluorescent lamp 16D and the pellet is not irradiated by light from the front and the back at the same time, thus making it possible to eliminate false positive identification of a nondefective pellet as a defective pellet.

Having the above-described pellets pass in front of the CCD line sensor 18A that observes the front of the pellet after passing in front of the CCD line sensor 18B that observes the back of the pellets enables defective pellets to be identified with substantially 100 percent accuracy without overlooking minute black spots adhering to the pellets. In addition, since the backgrounds 19A, 19B are broad and moreover curved, the inspection areas of the CCD line sensors extend in both the latitudinal as well as the downstream directions, thus virtually eliminating overlooking defective pellets on the parabolic trajectory L.

When a pellet on the parabolic trajectory L is identified as defective, the ejectors 20 corresponding to inspection areas of the CCD line sensors 18A and 18B are operated with a slight time delay to expel that pellet onto the defective pellet discharge trough 22.

The shapes of the backgrounds 19A, 19B are determined in advance and the angles and the like thereof cannot be changed. Therefore, the light level may be adjusted using the fluorescent lamps 16A-16D, for example increasing or decreasing the light level by changing the supply voltage of the fluorescent lamps or adjusting the brightness by changing the type of fluorescent lamp. The light level may then be adjusted so that the light levels of the backgrounds 19A, 19B and the nondefective pellets that make up the majority of the raw material pellets always match.

Since the backgrounds 19A, 19B are broad and moreover curved convexly or concavely so as to follow the parabolic trajectory L in the downstream direction, dust can gather on the curved portions. Accordingly, wipers, not shown, for removing dust and the like from the background 19A, 19B may be provided.

What is claimed is:

1. A pellet separator comprising:
a supplying unit for supplying pellets;
a conveying unit for conveying the pellets supplied from said supplying section at a constant flow rate and a constant speed to be released in a substantially horizontal direction;
a plurality of optical detecting units arranged at positions on opposite sides of a parabolic trajectory of the pellets released from said conveying section for detecting defective pellets, said plurality of optical detecting units including
a first detecting unit having first illumination means for illuminating front surfaces of the pellets, a first sensor for observing the front surfaces of the pellets and a first background arranged on a side of the parabolic trajectory opposite to a side on which said first illumination means and said first sensor are arranged, and a second detecting unit having second illumination means for illuminating back surfaces of the pellets, a second sensor for observing the back surfaces of the pellets and a second background arranged on a side of the parabolic trajectory opposite to a side on which the second illumination means and the second sensor are arranged,
said first background and said second background being arranged in the vicinity of the parabolic trajectory and formed to be curved along the parabolic trajectory; and
a removing unit for removing defective pellet from the parabolic trajectory based on detection of defective pellets by said plurality of optical detecting units.

2. A pellet separator according to claim 1, a distance between said first background and the parabolic trajectory and a distance between said second background and the parabolic track are not greater than 10 mm.

3. A pellet separator according to claim 1, wherein said conveyer unit comprises a continuous conveyer belt.
